(19) United States
(12) Patent Application Publication
(10) Pub. No.: US 2026/0105689 A1
(43) Pub. Date: Apr. 16, 2026

(54) METHOD FOR CREATING 3D OBJECTS USING AERIAL PHOTOGRAPHY

(71) Applicant: NEO SPECTRA Co., Ltd., Seoul (KR)

(72) Inventors: Dong Kwon SUNG, Seongnam-si (KR); Ho Yon JANG, Incheon (KR); Jungkyu CHOI, Seoul (KR); Young Woon JANG, Goyang-si (KR); Dawit YONG, Seoul (KR); Dohee HWANG, Seoul (KR); Yeon Woo KIM, Seoul (KR); Gye Beom JEON, Seoul (KR); Robert Igorevich PAK, Seoul (KR); Sua SHIN, Seoul (KR); Eungsik AHN, Seongnam-si (KR); Minsu KANG, Hwaseong-si (KR)

(73) Assignee: NEO SPECTRA Co., Ltd., Seoul (KR)

(21) Appl. No.: 19/349,728

(22) Filed: Oct. 3, 2025

(30) Foreign Application Priority Data
Oct. 14, 2024 (KR) 10-2024-0139403

(51) Int. Cl. G06T 17/05; G06T 17/20; G06V 10/24; G06V 10/26; G06V 10/82; G06V 20/10; G06V 20/17

(52) U.S. Cl. CPC G06T 17/05; G06T 17/20; G06V 10/247; G06V 10/26; G06V 10/82; G06V 20/17; G06V 20/176

(57) ABSTRACT

A method for generating three-dimensional objects includes an initial spatial object generation step, a mapping candidate selection step, and an intermediate texture selection step. An aerial image is a building image captured from the air using an imaging device. In the initial spatial object generation step, a processing device generates an initial spatial object, a 3D object corresponding to the building based on aerial images. A building face is defined on a surface of the building. A building face normal vector perpendicular to the building face is defined. At least one of the aerial images includes an initial texture corresponding to the building face. A photographing direction vector in the direction of the building face from the imaging device is defined for each of the aerial images. The processing device selects, as a mapping candidate aerial image, one of the aerial images that includes the initial texture and for which a dot product between the photographing direction vector and the building-face normal vector is negative. The initial spatial object includes an object surface corresponding to the building face. In the intermediate texture selection step, the processing device selects, as an intermediate texture, the initial texture having the largest area among initial textures corresponding to the mapping candidate aerial images.

### CROSS REFERENCE TO RELATED APPLICATION(S)

This application claims priority under 35 U.S.C. § 119 to Korean Patent Application No. 10-2024-0139403, filed on Oct. 14, 2024, in the Korean Intellectual Property Office, the disclosure of which is incorporated by reference herein in its entirety.

### BACKGROUND

### 1. Field

The present disclosure relates to a method for generating three-dimensional (3D) objects corresponding to buildings. More particularly, the present disclosure relates to a method for generating 3D objects using two-dimensional (2D) aerial images.

### 2. Description of the Related Art

A digital twin refers to a technology that enables monitoring and simulation of a real-world object—such as a building, facility, or terrain—by utilizing a digital replica of the object.

To implement a digital twin, it is necessary to model the target and generate a corresponding 3D object. Although techniques have been proposed for generating 3D objects based on aerial images collected by aircraft or drones, such processes are still performed manually, resulting in inefficiencies.

### SUMMARY

The present disclosure addresses the above-described issues by providing a method for generating three-dimensional (3D) objects using aerial imagery, which improves process efficiency by utilizing various artificial intelligence models.

According to an embodiment of the present disclosure, a method for generating 3D objects using aerial imagery may include: an initial spatial object generation step, a mapping candidate selection step, and an intermediate texture selection step. The aerial imagery may be images of buildings captured from the air using an imaging device. In the initial spatial object generation step, a processing device may generate an initial spatial object, which is a 3D object corresponding to a building, based on a plurality of aerial images. A building surface may be defined on the outer surface of the building. A building face normal vector perpendicular to the building surface may be defined. At least one of the aerial images may include an initial texture corresponding to the building surface. For each of the aerial images, a photographing direction vector from the imaging device toward the building surface may be defined. In the mapping candidate selection step, the processing device may select, as a mapping candidate aerial image, an aerial image that includes the initial texture and for which the dot product of the photographing direction vector and the building face normal vector is negative. The initial spatial object may include an object surface corresponding to the building surface. In the intermediate texture selection step, the processing device may select, from among a plurality of initial textures corresponding to a plurality of mapping candidate aerial images, the initial texture having the largest area as the intermediate texture.

In an embodiment of the present disclosure, among the plurality of aerial images, a first aerial image and a second aerial image may be aerial images of a building captured from different directions. The initial spatial object generation step may include a roof polygon generation step, a feature point matching step, a spatial coordinate calculation step, a building height calculation step, and a modeling step. In the roof polygon generation step, the processing device may extract a roof polygon corresponding to a roof of the building from the first aerial image. In the feature point matching step, the processing device may select at least one first feature point having a predetermined characteristic from among a plurality of polygon pixels corresponding to the roof polygon in the first aerial image and may select at least one second feature point corresponding to the first feature point in the second aerial image. In the spatial coordinate calculation step, the processing device may compute feature point spatial coordinate information by applying a forward intersection method using collinearity conditions based on the first and second feature points. The feature point spatial coordinate information may be either the spatial coordinates of the first feature point or the spatial coordinates of the second feature point. In the building height calculation step, the processing device may calculate the height of the building using the feature point spatial coordinate information. In the modeling step, the processing device may generate the initial spatial object based on the roof polygon and the height of the building.

In an embodiment of the present disclosure, at least one of a first artificial intelligence (AI) model and a second AI model may be stored in the processing device.

The first AI model may be configured to extract at least one first polygon as a vector image from the aerial image through polygon mapping. The backbone of each of the first AI model and the second AI model may be a neural network model. The second AI model may be configured to extract at least one second polygon as a raster image from the aerial image through object segmentation. In the roof polygon generation step, the processing device may extract the roof polygon from the first aerial image using at least one of the first AI model and the second AI model.

In an embodiment of the present disclosure, the second AI model may be configured to convert the second polygon into a vector image.

In the feature point matching step according to an embodiment of the present disclosure, the processing device may derive at least one first feature point and at least one second feature point using at least one of KAZE, ORB, and SIFT.

In the feature point matching step, the processing device may derive at least one second feature point using at least one of BFMatcher and FLANN.

In the building height calculation step, the processing device may further use a pre-stored digital elevation model (DEM) to calculate the height of the building.

In the modeling step according to an embodiment of the present disclosure, the processing device may perform tessellation on the roof polygon to divide the roof polygon into a plurality of triangles and may generate the initial spatial object based on the plurality of triangles and the height of the building.

In the modeling step, the processing device may perform the tessellation using a sweeping line algorithm and an ear clipping algorithm.

In the mapping candidate selection step according to an embodiment of the present disclosure, the processing device may select the mapping candidate aerial image using a backface culling algorithm.

The method for generating 3D objects using aerial imagery according to an embodiment of the present disclosure may further include a final texture generation step. In the final texture generation step, the processing device may generate a final texture by applying an affine transformation to the intermediate texture and then performing interpolation.

The method may further include an atlas generation step. The building surface may be provided in plurality. In the atlas generation step, the processing device may perform the mapping candidate selection step, the intermediate texture selection step, and the final texture generation step iteratively for each of the plurality of building faces to generate a plurality of final textures. Moreover, the processing device may generate an atlas using a binary space partitioning tree based on the plurality of final textures.

The method may further include a final spatial object generation step. In the final spatial object generation step, the processing device may generate a final spatial object by mapping the plurality of final textures, based on the atlas, onto the initial spatial object.

The method may further include an inpainting step. In the inpainting step, the processing device may perform inpainting on the final spatial object using a third AI model. The backbone of the third AI model may be a neural network model.

The method may further include a super-resolution step. In the super-resolution step, the processing device may enhance the resolution of the final spatial object using a super-resolution model. The backbone of the super-resolution model may be a neural network model. In an embodiment of the present disclosure, the neural network model serving as the backbone of the super-resolution model may be a deep convolutional network. The super-resolution model may be trained using a plurality of images having different resolutions. The super-resolution model may be configured to adjust the resolution of the plurality of images using an attention mechanism.

The method may further include a texture editing step. In the texture editing step, one of the plurality of mapped final textures may be a first final texture, and another one of the plurality of mapped final textures may be a second final texture. The processing device may edit the second final texture using at least a portion of a pre-stored predetermined texture or at least a portion of the first final texture.

In an embodiment of the present disclosure, the initial spatial object generation step may further include a preprocessing step. Each of the plurality of aerial images may include a plurality of pixels arranged on a plane extending in the x-axis and y-axis directions. The position of each of the pixels may be determined by an x-coordinate and a y-coordinate. The first aerial image may include a plurality of polygon pixels corresponding to the roof polygon. Among the plurality of x-coordinates corresponding to the plurality of polygon pixels, the smallest value may be a first left boundary value, and the largest value may be a first right boundary value. Among the plurality of y-coordinates corresponding to the plurality of polygon pixels, the smallest value may be a first lower boundary value, and the largest value may be a first upper boundary value. In the first aerial image, an area where the first aerial image overlaps with the second aerial image may be an overlapping region, while an area where the first aerial image does not overlap with the second aerial image may be a non-overlapping region. An overlapping direction may be a direction from the center of gravity of the non-overlapping region to the center of gravity of the overlapping region. A non-overlapping length may be a length measured in the overlap direction across the non-overlapping region. In the preprocessing step, if the overlap direction is parallel to the x-axis direction, the processing device may remove a cropping target region from the second aerial image using Equation 1 or Equation 2. If the overlap direction is parallel to the y-axis direction, the processing device may remove the cropping target region from the second aerial image using Equation 3 or Equation 4. The cropping target region may be an outer region of the second aerial image bounded by lines defined by: an x-coordinate equal to a second left boundary value, a y-coordinate equal to a second lower boundary value, an x-coordinate equal to a second right boundary value, and a y-coordinate equal to a second upper boundary value.

$$X min 2 = X min 1 + V min , X max 2 = X max 1 + V max \qquad [ Equation 1 ]$$

$$Y min 2 = Y min 1 , Y max 2 = Y max 1$$

$$X min 2 = X min 1 - V max , X max 1 = X max 1 - V min \qquad [ Equation 2 ]$$

$$Y min 2 = Y min 1 , Y max 1 = Y max 1$$

$$X min 2 = X min 1 , X max 2 = X max 1 \qquad [ Equation 3 ]$$

$$Y min 2 = Y min 1 + V min , Y max 2 = Y max 1 + V max$$

$$X min 2 = X min 1 , X max 2 = X max 1 \qquad [ Equation 4 ]$$

$$Y min 2 = Y min 1 - V min , Y max 2 = Y max 1 - V max$$

In each of Equations 1 to 4, Xmin2 is the second left boundary value, Ymin2 is the second lower boundary value, Xmax2 is the second right boundary value, and Ymax2 is the second upper boundary value. Xmin1 is the first left boundary value, Xmax1 is the first right boundary value, Ymin1 is the first lower boundary value, and Ymax1 is the first upper boundary value. Vmin may be a minimum value of the non-overlapping length, and Vmax may be a maximum value of the non-overlapping length. In the feature point matching step, the second aerial image may be the second aerial image with the cropping target region removed.

In the preprocessing step, when the overlap direction is opposite to the x-axis direction, the processing device may remove the cropping target region from the second aerial image using Equation 1. When the overlap direction is the same as the x-axis direction, the processing device may remove the cropping target region from the second aerial image using Equation 2. When the overlap direction is opposite to the y-axis direction, the processing device may remove the cropping target region from the second aerial image using Equation 3. When the overlap direction is the same as the y-axis direction, the processing device may remove the cropping target region from the second aerial image using Equation 4.

According to an embodiment of the present disclosure, by utilizing various AI models, a method for generating 3D objects with improved efficiency in the object generation process can be provided.

### BRIEF DESCRIPTION OF THE DRAWINGS

These and/or other features will become apparent and more readily appreciated from the following description of the embodiments, taken in conjunction with the accompanying drawings in which:

FIG. 1 is a diagram illustrating the generation of a plurality of 3D objects through a method for generating 3D objects using aerial imagery according to an embodiment of the present disclosure;

FIG. 2 is a flowchart illustrating a method for generating 3D objects according to an embodiment of the present disclosure;

FIG. 3 is a detailed flowchart illustrating the initial spatial object generation step according to an embodiment of the present disclosure;

FIGS. 4A through 4F are diagrams illustrating detailed steps of the initial spatial object generation step;

FIGS. 5A and 5B are diagrams illustrating the process for selecting a mapping candidate aerial image in the mapping candidate selection step according to an embodiment of the present disclosure;

FIG. 6 is a diagram illustrating the intermediate texture selection step according to an embodiment of the present disclosure;

FIG. 7 is a diagram illustrating the final texture generation step according to an embodiment of the present disclosure;

FIG. 8 is a diagram illustrating the atlas generation step according to an embodiment of the present disclosure;

FIG. 9 is a diagram illustrating the final spatial object generation step according to an embodiment of the present disclosure;

FIGS. 10A and 10B are diagrams illustrating a portion of a final spatial object in the inpainting step according to an embodiment of the present disclosure;

FIGS. 11A and 11B are diagrams illustrating the super-resolution step according to an embodiment of the present disclosure;

FIGS. 12A through 12D are diagrams illustrating the texture editing step according to an embodiment of the present disclosure; and

FIGS. 13A through 13E are diagrams illustrating the preprocessing step according to an embodiment of the present disclosure.

### DETAILED DESCRIPTION

References will now be made in detail to certain embodiments, of which examples are illustrated in the accompanying drawings, where like reference numerals refer to like elements throughout. The embodiments may have a variety of forms and permutations, but the present disclosure shall by no means be construed as being limited to the described embodiments. Rather, the present disclosure shall be construed to encompass all forms, permutations, equivalents and substitutes covered by the technical ideas and scope of the present disclosure. Accordingly, the embodiments are merely described below, by referring to the figures, to explain features of the present disclosure.

Hereinafter, certain preferred embodiments of the present disclosure will be described in greater detail with reference to the accompanying drawings, in which the proportions and dimensions of elements may be exaggerated for effective description and illustration of the associated technical features.

The term “include,” “comprise,” or similar terminology is intended to specify the presence of features, numbers, steps, operations, elements, parts, or combinations thereof described in the specification, and should not be construed as precluding the possibility of the presence or addition of one or more other features, numbers, steps, operations, elements, parts, or combinations thereof.

Additionally, when an element is described as being “on” another element, it means that the element may be positioned above or below the referenced element and does not necessarily imply an upward position based on gravitational direction.

Furthermore, when an element is described as being “connected” or “coupled” to another element, it should be understood to encompass cases where the element is directly connected or coupled to the other element as well as cases where the element is indirectly connected or coupled through another element.

In addition, terms such as first and second may be used to describe certain elements, but such terms are merely for distinguishing one element from another and are not intended to limit the essence, sequence, or order of the corresponding elements.

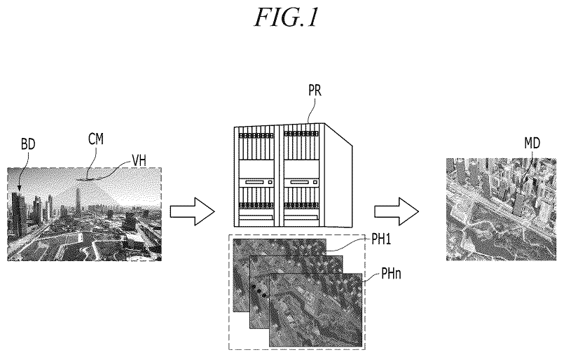

FIG. 1 is a diagram illustrating the generation of a plurality of three-dimensional objects MD using a method OBM for generating 3D objects using aerial imagery as shown in the present disclosure.

Referring to FIG. 1, aerial imagery PH may be imagery captured of a building BD from the air using an imaging device CM. For example, aerial imagery PH may be collected via an imaging device CM mounted on an aircraft VH, which may be an airplane or a drone. However, the aircraft VH is not limited thereto and may be any device capable of flying. Using the method OBM of the present disclosure, a plurality of three-dimensional objects MD corresponding to a plurality of buildings BD may be generated based on a plurality of two-dimensional aerial images PH1 to PHn.

In an embodiment of the present disclosure, the method OBM for generating 3D objects using aerial imagery may be implemented using a processing device PR. The processing device PR may receive aerial images PH from an external source.

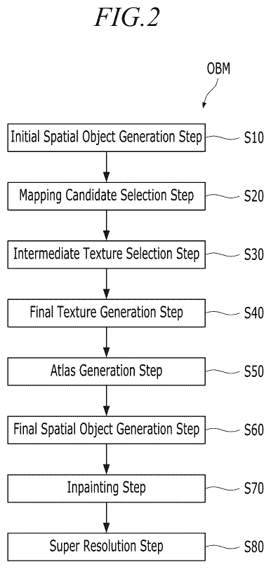

FIG. 2 is a flowchart illustrating the method OBM for generating 3D objects according to an embodiment of the present disclosure. Referring to FIG. 2, the method OBM may include an initial spatial object generation step S10, a mapping candidate selection step S20, an intermediate texture selection step S30, a final texture generation step S40, an atlas generation step S50, a final spatial object generation step S60, an inpainting step S70, and a super-resolution step S80.

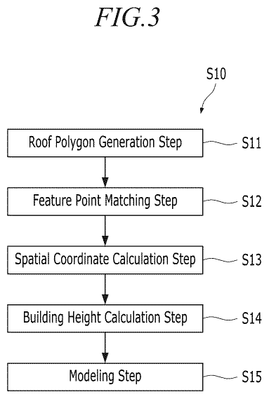

FIG. 3 is a detailed flowchart illustrating the initial spatial object generation step S10 in an embodiment of the present disclosure. Referring to FIG. 3, the initial spatial object generation step S10 may include a roof polygon generation step S11, a feature point matching step S12, a spatial coordinate calculation step S13, a building height calculation step S14, and a modeling step S15.

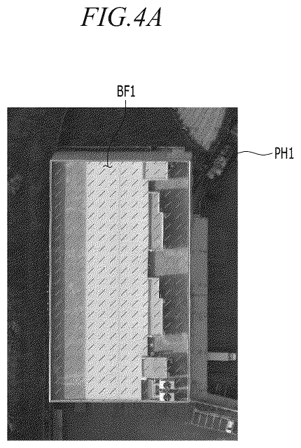

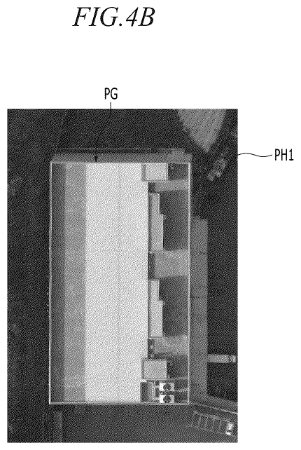

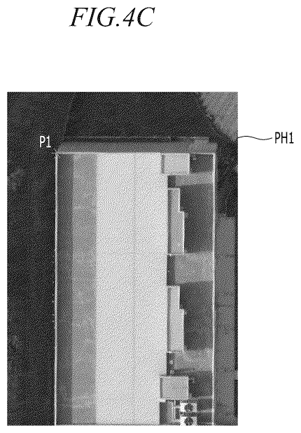

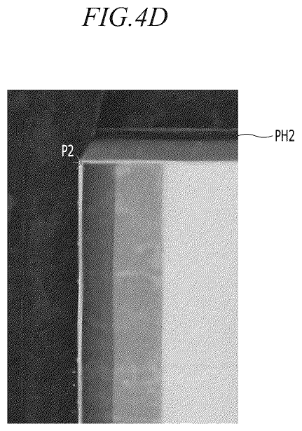

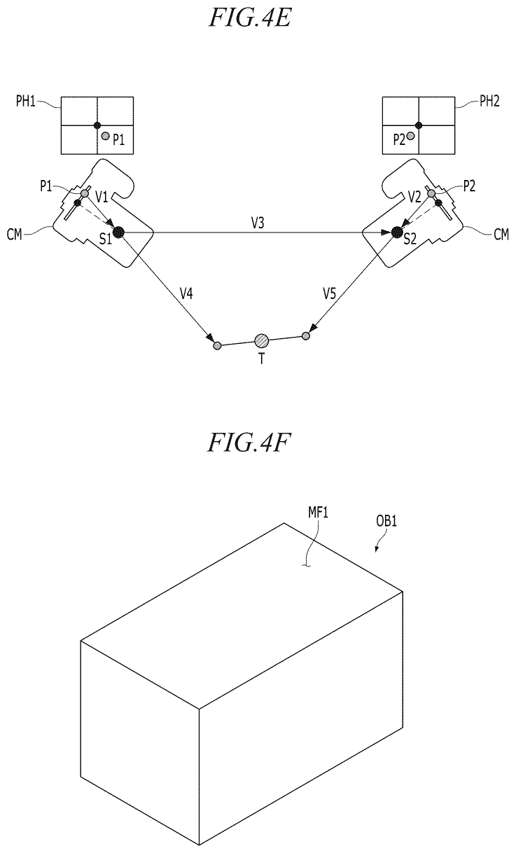

FIGS. 4A through 4F are diagrams illustrating detailed steps of the initial spatial object generation step S10. Referring to FIGS. 4A through 4F, in the initial spatial object generation step S10, processing device PR may generate an initial spatial object OB1 based on the plurality of aerial images PH1 to PHn. The initial spatial object OB1 may be a 3D object corresponding to a building BD.

FIGS. 4A and 4B are diagrams illustrating the roof polygon generation step S11 according to an embodiment of the present disclosure. A plurality of building faces may be defined on the surface of the building BD. FIGS. 4A and 4B each show an enlarged view of a portion of a first aerial image PH1 corresponding to a first building face BF1. The first building face BF1 may correspond to a roof among the plurality of building faces.

Referring to FIGS. 4A and 4B, in the roof polygon generation step S11, the processing device PR may extract a roof polygon PG corresponding to the first building face BF1 from the first aerial image PH1. The roof polygon PG may then be used to generate the initial spatial object OB1.

At least one of a first artificial intelligence (AI) model and a second AI model may be stored in the processing device PR. In the roof polygon generation step S11, the processing device PR may extract the roof polygon PG from the first aerial image PH1 using at least one of the first and second AI models.

The first AI model may extract at least one first polygon from the aerial image via polygon mapping, based on HRNetV2 and a plurality of synthetic neural networks. The first polygon may be a vector image. That is, the first polygon extracted via the first AI model may be vector data and may be stored in a format such as SHP, GeoJSON, or KML.

The second AI model may extract at least one second polygon from the aerial image as a raster image through object segmentation, based on at least one of U-Net, Deeplab, DeeplabV3+, and HRNet. In one embodiment, the second AI model may convert the second polygon into a vector image using a skeletonization algorithm and a loss function. That is, the second polygon extracted using the skeletonization algorithm and loss function may be vector data and may be stored in a format such as SHP, GeoJSON, or KML.

However, the first and second AI models of the present disclosure are not limited to the examples described above. The first AI model of the present disclosure may be any model as long as it is capable of extracting polygons from an image as vector images through polygon mapping, and the second AI model of the present disclosure may be any model as long as it is capable of extracting polygons as raster images from an image through object segmentation.

FIGS. 4C and 4D are diagrams illustrating the feature point matching step S12 according to an embodiment of the present disclosure. Referring to FIGS. 4C and 4D, among the plurality of aerial images PH1 to PHn, the first aerial image PH1 and second aerial image PH2 may be aerial images of the same building BD captured from different directions.

In the feature point matching step S12 according to an embodiment of the present disclosure, the processing device PR may select at least one first feature point P1 having a predetermined characteristic from among a plurality of polygon pixels corresponding to the roof polygon PG in the first aerial image PH1, and may select at least one second feature point P2 corresponding to the first feature point P1 in the second aerial image PH2. The second feature point P2 may also be a pixel having a predetermined characteristic in the second aerial image PH2.

In an embodiment of the present disclosure, each of the first feature point P1 and the second feature point P2 may be provided in plurality. A feature point pair may refer to a set of any two feature points sharing similar characteristics, and the processing device PR may select a plurality of feature point pairs from the first and second aerial images PH1 and PH2 in the feature point matching step S12.

In the feature point matching step S12, the processing device PR may use at least one of KAZE, ORB (Oriented FAST and Rotated BRIEF), and SIFT (Scale-Invariant Feature Transform) to detect at least one first feature point P1.

KAZE is typically used to extract edges or textures in an image and has the advantage of being robust to noise. ORB combines the FAST keypoint detector with the BRIEF descriptor and is advantageous in terms of low computational cost. SIFT uses Gaussian blurring and difference-of-Gaussian to detect feature points and is capable of extracting complex features with high reliability.

In the feature point matching step S12, the processing device PR may use at least one of BFMatcher (Brute-Force Matcher) and FLANN (Fast Library for Approximate Nearest Neighbors) to detect at least one second feature point P2.

BFMatcher calculates distances between all feature point pairs and selects the closest matching point, offering the advantages of simple implementation and precise feature matching due to the exhaustive comparison. FLANN is a library for approximate nearest neighbor searches. Unlike BFMatcher, FLANN uses approximation techniques rather than comparing all pairs, enabling faster matching of the feature points. For example, the approximation techniques used in FLANN may include at least one of a KD-tree, hash-based methods, and other fast search algorithms.

FIG. 4E is a diagram illustrating the spatial coordinate calculation step S13 according to an embodiment of the present disclosure. In the present specification, the collinearity condition refers to the condition that a shooting point S where the lens of the imaging device is located, a feature point P which is positioned in the image, and a ground point T which corresponds to the feature point P and is positioned on the ground must lie on a straight line. Furthermore, the forward intersection method refers to a technique for calculating the actual spatial position of a target in a 3D space using two or more photographs taken from different locations.

In the spatial coordinate calculation step S13 according to an embodiment of the present disclosure, the processing device PR may compute feature point spatial coordinate information using a forward intersection method based on the collinearity condition, with reference to the first feature point P1 and the second feature point P2. In an embodiment, the feature point spatial coordinate information may be either the spatial coordinates of the ground point corresponding to the first feature point P1 or the spatial coordinates of the ground point corresponding to the second feature point P2.

Referring to FIG. 4E, the ground point T may be a point on the ground corresponding to the first feature point P1 and the second feature point P2. The first aerial image PH1 may be an aerial image of the ground point T captured from a first shooting point S1, and the second aerial image PH2 may be an aerial image of the ground point T captured from a second shooting point S2 different from the first shooting point S1.

Specifically, in the spatial coordinate calculation step S13, the processing device PR may compute the spatial coordinates of the ground point T using at least one of a first vector V1 from the first feature point P1 to the first shooting point S1, a second vector V2 from the second feature point P2 to the second shooting point S2, a third vector V3 from the first shooting point S1 to the second shooting point S2, a fourth vector V4 from the first feature point P1 to the ground, a fifth vector V5 from the second feature point P2 to the ground, a sixth vector (not shown) from the first shooting point S1 to the ground point T, and a seventh vector from the second shooting point S2 to the ground point T.

In the building height calculation step S14 according to an embodiment of the present disclosure, the processing device PR may calculate the height of the building BD using the feature point spatial coordinate information. In the building height calculation step S14, the processing device PR may further use a pre-stored digital elevation model (DEM) to calculate the height of the building BD. In the present specification, the digital elevation model refers to a model that digitally represents elevation information of the earth's surface.

FIG. 4F is a diagram illustrating the modeling step S15 according to an embodiment of the present disclosure. Referring to FIG. 4F, in the modeling step S15, the processing device PR may generate the initial spatial object OB1 based on the roof polygon PG and the height of the building BD. The initial spatial object OB1 may include a first object surface MF1 corresponding to the first building face BF1 shown in FIGS. 4A and 4B.

Tessellation generally refers to the process of dividing a surface of a three-dimensional object into a plurality of triangles or quadrilaterals. Tessellation enables fine representation and efficient rendering of 3D objects.

In the modeling step S15 according to an embodiment of the present disclosure, the processing device PR may perform tessellation on the roof polygon PG to divide the roof polygon PG into a plurality of triangles. The processing device PR may generate the initial spatial object OB1 based on the plurality of triangles and the height of the building BD.

In the modeling step S15, the processing device PR may perform tessellation using a Sweeping Line Algorithm and an Ear Clipping Algorithm. Each of the Sweeping Line Algorithm and the Ear Clipping Algorithm may be an algorithm used for performing tessellation.

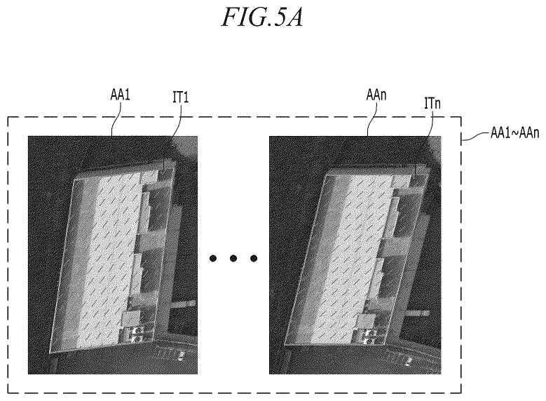

FIGS. 5A and 5B are diagrams illustrating the process for selecting a mapping candidate aerial image AA in the mapping candidate selection step S20 according to an embodiment of the present disclosure. In the mapping candidate selection step S20, the processing device PR may select a mapping candidate aerial image AA from among the plurality of aerial images PH1 to PHn.

Referring to FIG. 5A, the mapping candidate aerial image AA may be one of the aerial images PH1 to PHn that includes an initial texture IT corresponding to the first building face BF1. In an embodiment of the present disclosure, the mapping candidate aerial image AA may be provided in plurality. That is, each of the plurality of mapping candidate aerial images AA1 to AAn may be an aerial image PH including a corresponding initial texture IT1 to ITn.

Referring to FIG. 5B, a photographing direction vector CV may be defined as a vector from the imaging device CM toward the center C1 of the first building face. In other words, the photographing direction vector CV may indicate the direction in which the mapping candidate aerial image AA was captured. A first building face normal vector NV1 may be defined as a vector perpendicular to the first building face BF1.

A photographing direction vector CV may be defined for each of the plurality of aerial images PH1 to PHn, and the mapping candidate aerial image AA may be one of the aerial images PH1 to PHn in which the dot product of the photographing direction vector CV and the first building face normal vector NV1 is negative. That is, the mapping candidate aerial image AA may be an aerial image PH captured when the imaging device CM and the first building face BF1 are facing each other. In contrast, an aerial image PH for which the dot product of the photographing direction vector CV and the first building face normal vector NV1 is positive may be an image captured when the imaging device CM and the first building face BF1 are not facing each other.

In the mapping candidate selection step S20 according to an embodiment of the present disclosure, the processing device PR may use a Backface Culling Algorithm to select the mapping candidate aerial image AA. The Backface Culling Algorithm may be an algorithm used to distinguish between visible and non-visible surfaces from the perspective of the imaging device CM in order to improve rendering performance. The processing device PR may determine whether a specific surface is visible from the imaging device CM using the Backface Culling Algorithm. Accordingly, since computations are not performed for surfaces that are not visible from the imaging device CM, computational efficiency may be improved.

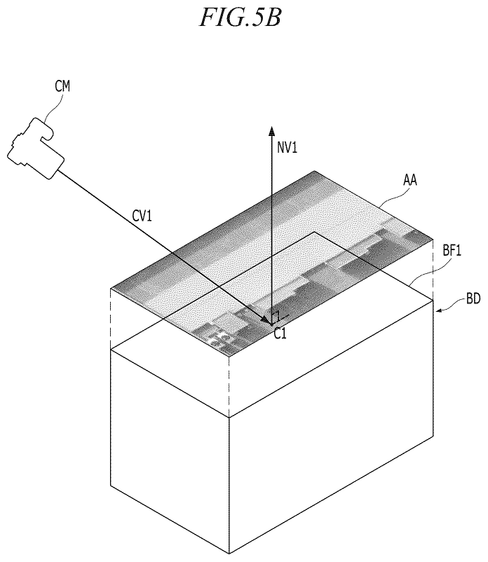

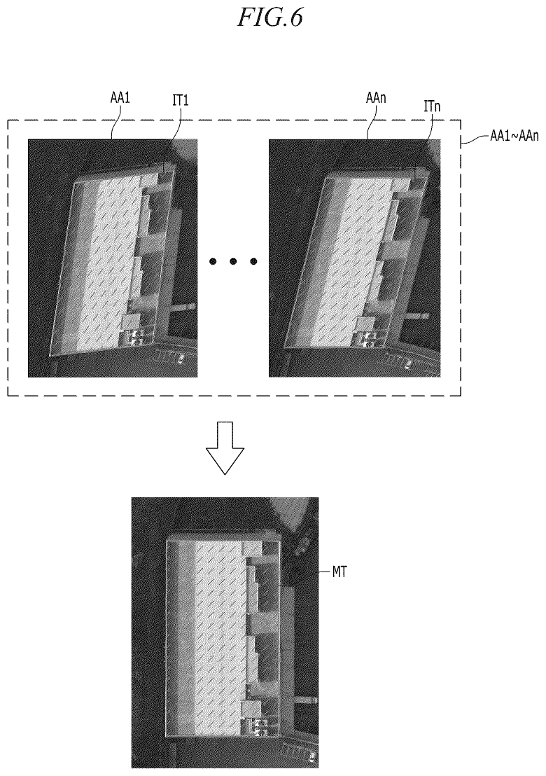

FIG. 6 is a diagram illustrating the intermediate texture selection step S30 according to an embodiment of the present disclosure. Referring to FIG. 6, in the intermediate texture selection step S30, the processing device PR may select, as an intermediate texture MT, the initial texture having the largest area from among the plurality of initial textures IT1 to ITn corresponding to the plurality of mapping candidate aerial images AA1 to AAn.

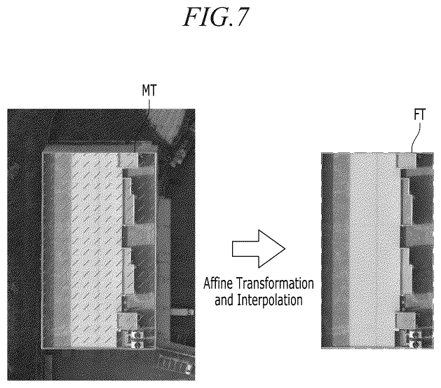

FIG. 7 is a diagram illustrating the final texture generation step S40 according to an embodiment of the present disclosure. Referring to FIG. 7, in the final texture generation step S40, the processing device PR may generate a final texture FT by applying an affine transformation to the intermediate texture MT followed by interpolation. The affine transformation may be a method for mapping the texture to a 3D object while minimizing distortion.

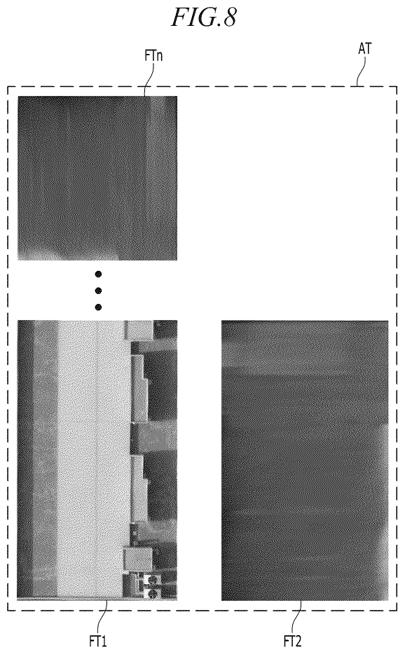

FIG. 8 is a diagram illustrating the atlas generation step S50 according to an embodiment of the present disclosure. Referring to FIG. 8, in the atlas generation step S50, the processing device PR may perform the mapping candidate selection step S20, the intermediate texture selection step S30, and the final texture generation step S40 iteratively for each of the plurality of building faces, thereby generating a plurality of final textures FT1 to FTn. The plurality of final textures FT1 to FTn may correspond, respectively, to the plurality of building faces.

In an embodiment of the present disclosure, the processing device PR may generate an atlas AT using a Binary Space Partitioning Tree based on the plurality of final textures FT1 to FTn. The Binary Space Partitioning Tree may be a method for efficiently arranging textures, preventing overlap between textures, and improving rendering performance in the process of generating the atlas AT.

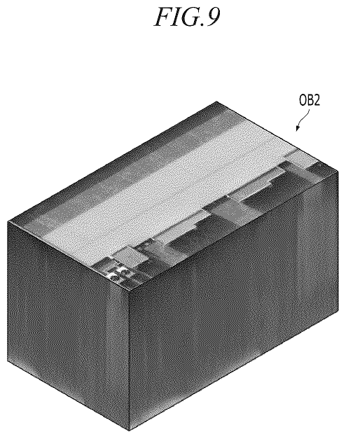

FIG. 9 is a diagram illustrating the final spatial object generation step S60 according to an embodiment of the present disclosure. Referring to FIG. 9, in the final spatial object generation step S60, the processing device PR may generate a final spatial object OB2 by mapping the plurality of final textures FT1 to FTn onto the initial spatial object OB1 based on the atlas AT. In the present specification, the final spatial object OB2 refers to the three-dimensional object MD.

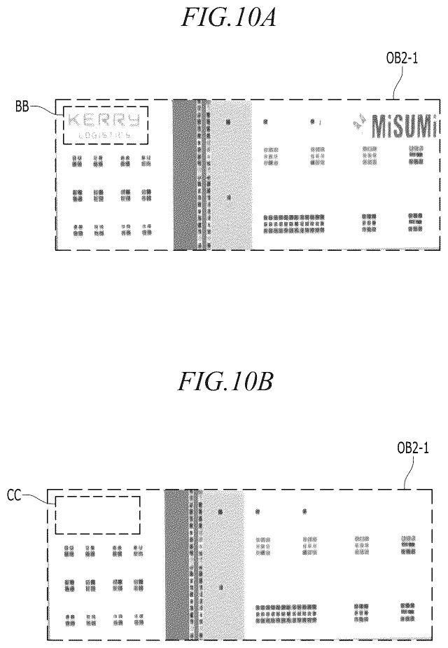

FIGS. 10A and 10B are diagrams illustrating a portion of a final spatial object OB2-1 in the inpainting step S70 according to an embodiment of the present disclosure. For convenience of explanation, the final spatial object OB2-1 that is different from the final spatial object OB2 shown in FIG. 9 is illustrated in FIGS. 10A and 10B.

Inpainting refers to a technique for restoring defects or missing parts in a three-dimensional object. Referring to FIGS. 10A and 10B, the processing device PR may perform inpainting to remove an unnecessary portion BB from the final spatial object OB2-1 and naturally fill another portion CC with suitable content. In the inpainting step S70, the processing device PR may perform inpainting on the final spatial object OB2-1 using a third AI model. The backbone of the third AI model may be a neural network model. The third AI model may use at least one of a Mobile Inpainting GAN and LaMa (Large Mask inpainting model). The Mobile Inpainting GAN is an inpainting model based on a generative adversarial network (GAN), designed to operate efficiently on mobile devices, with the advantage of low computational load. LaMa is a large-mask inpainting model that has the advantage of effectively handling large masks.

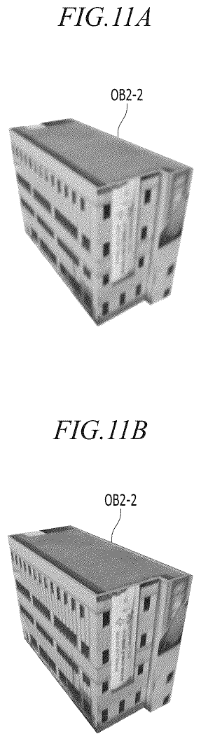

FIGS. 11A and 11B are diagrams illustrating the super-resolution step S80 according to an embodiment of the present disclosure. FIG. 11A illustrates an example of the final spatial object OB2-2 before the super-resolution step S80 is performed, and FIG. 11B illustrates an example of the final spatial object OB2-2 after the super-resolution step S80 is performed.

The processing device PR may enhance the resolution of the final spatial object OB2-2 through the super-resolution step S80. Referring to FIGS. 11A and 11B, in the super-resolution step S80, the processing device PR may use a super-resolution model to increase the resolution of the final spatial object. The backbone of the super-resolution model may be a neural network model. In an embodiment of the present disclosure, the backbone neural network model of the super-resolution model may be a deep convolutional network. The super-resolution model may be trained using a plurality of images having different resolutions. The super-resolution model may apply an attention mechanism to modify the resolutions of the plurality of images.

In the super-resolution step S80, the processing device PR may use a Hybrid Attention Transformer to enhance the resolution of the final spatial object OB2-2. The Hybrid Attention Transformer may be a transformer model utilizing a hybrid attention mechanism.

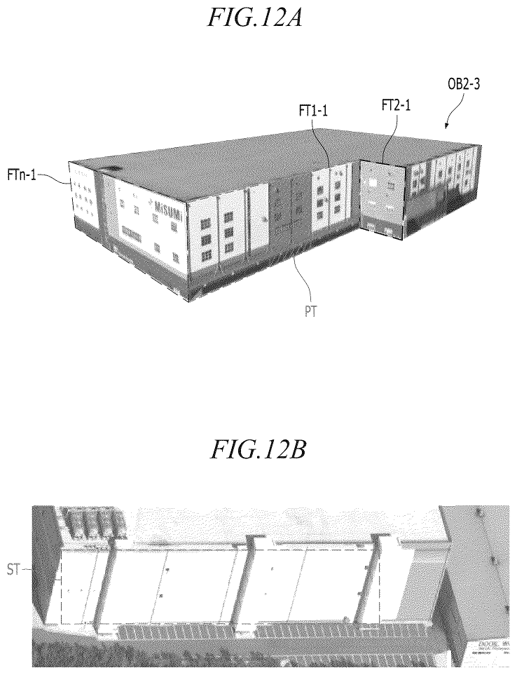

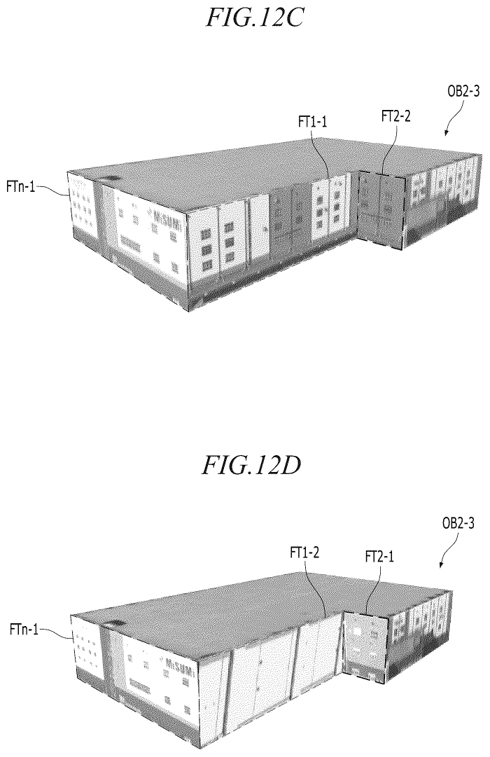

FIGS. 12A through 12D illustrate a texture editing step (not shown) according to an embodiment of the present disclosure. FIG. 12A illustrates a final spatial object OB2-3 before the texture editing step is performed. FIG. 12B illustrates a predetermined texture ST that has been pre-stored. Referring to FIG. 12A, one of a plurality of mapped final textures FT1-1 to FTn-1 may be a first final texture FT1-1, and another one of the plurality of mapped final textures FT1-1 to FTn-1 may be a second final texture FT2-1. Referring to FIG. 12B, in an embodiment of the present disclosure, the predetermined texture ST may be pre-stored in the processing device PR.

FIGS. 12C and 12D each illustrate the final spatial object OB2-3 after the texture editing step has been performed. Referring to FIGS. 12A and 12C, in the texture editing step, the processing device PR may edit the second final texture FT2-1 using at least a portion PT of the first final texture FT1-1. In the texture editing step, the second final texture FT2-1 of FIG. 12A may be edited into the second final texture FT2-2 shown in FIG. 12C.

Referring to FIGS. 12A, 12B, and 12D, in the texture editing step according to an embodiment of the present disclosure, the processing device PR may edit the first final texture FT1-1 using at least a portion of the pre-stored predetermined texture ST. In the texture editing step, the first final texture FT1-1 of FIG. 12A may be edited into the first final texture FT1-2 shown in FIG. 12D. Accordingly, in the method of the present disclosure, a user may edit the second final texture FT2-1 using either the first final texture FT1-1 or the predetermined texture ST.

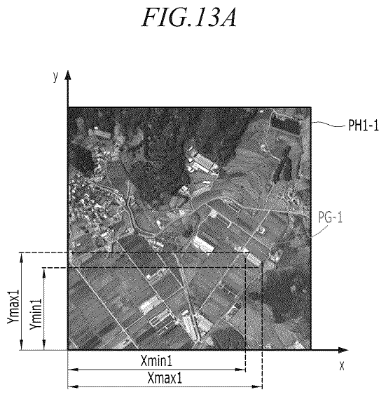

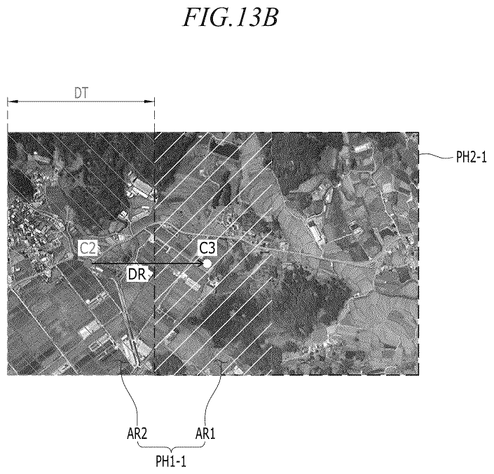

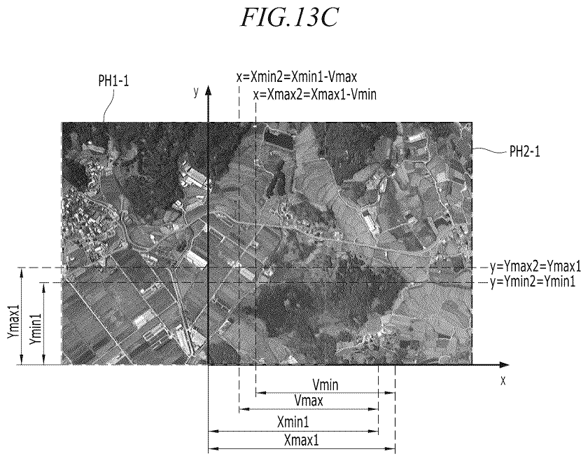

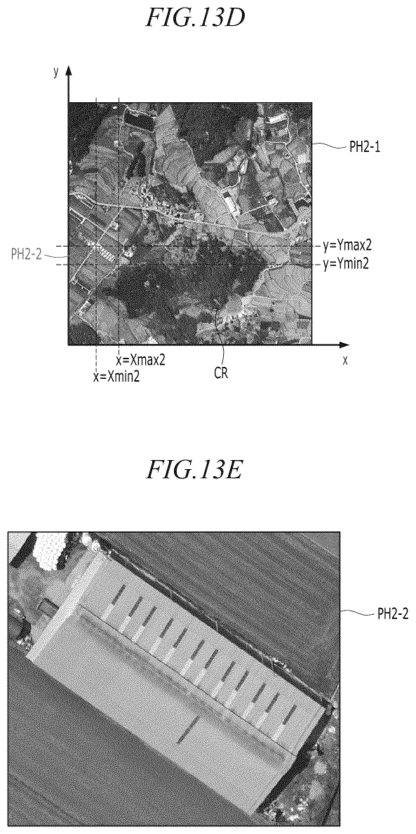

The initial spatial object generation step S10 according to an embodiment of the present disclosure may further include a preprocessing step (not shown). The preprocessing step will be described in greater detail below with reference to FIGS. 13A through 13E.

FIG. 13A illustrates a first aerial image PH1-1. Referring to FIG. 13A, each of the plurality of aerial images may include a plurality of pixels arranged on a plane extending in the x-axis and y-axis direction. The position of each of the plurality of pixels of one of the plurality of aerial images may be determined by an x-coordinate and a y-coordinate.

The first aerial image PH1-1 may include a plurality of polygon pixels corresponding to a roof polygon PG-1. Among the plurality of x-coordinates corresponding to the plurality of polygon pixels, the smallest value may be a first left boundary value Xmin1, and the largest value may be a first right boundary value Xmax1. Likewise, among the plurality of y-coordinates corresponding to the plurality of polygon pixels, the smallest value may be a first lower boundary value Ymin1, and the largest value may be a first upper boundary value Ymax1.

FIG. 13B illustrates an overlapping region AR1 and a non-overlapping region AR2 in the first aerial image PH1-1. The first aerial image PH1-1 and the second aerial image PH2-1 may be sequentially collected using an imaging device CM mounted on a moving aircraft VH. Accordingly, a portion of the first aerial image PH1-1 may overlap with the second aerial image PH2-1.

Referring to FIG. 13B, the overlapping region AR1 may be a region of the first aerial image PH1-1 that overlaps with the second aerial image PH2-1, whereas the non-overlapping region AR2 may be a region of the first aerial image PH1-1 that does not overlap with the second aerial image PH2-1. An overlapping direction DR may be a direction from the center of gravity C2 of the non-overlapping region AR2 to the center of gravity C3 of the overlapping region AR1. A non-overlapping length DT may be a length of the non-overlapping region AR2 measured along the overlap direction DR. In an embodiment of the present disclosure, the non-overlapping length DT may be provided as a range of values.

The roof polygon PG-1 may be located within the overlapping region AR1. Thus, if the feature point matching step S12 is performed only on a region of the second aerial image PH2-1 corresponding to the roof polygon PG-1, the computational load that the processing device PR has to perform may be less than the computational load when the processing device PR performs the feature point matching step S12 across the entire second aerial image PH2-1.

FIGS. 13C and 13D illustrate how the processing device PR determines a cropping target region CR in the second aerial image PH2-1. In the present disclosure, the cropping target region CR refers to a region of an aerial image PH that may be removed without affecting the execution of the feature point matching step S12 by the processing device PR. Referring to FIG. 13C, a preprocessing step of the present disclosure may be a process for reducing the computational load that has to be carried out by the processing device PR by removing the cropping target region CR that does not correspond to the roof polygon PG from the second aerial image PH2-1.

Referring to FIGS. 13C and 13D, in the preprocessing step, the cropping target region CR may be an outer region of an area PH2-2 of the second aerial image PH2-1 that is bounded by a line where the x-coordinate is equal to the second left boundary value (x=Xmin2), a line where the y-coordinate is equal to the second lower boundary value (y=Ymin2), a line where the x-coordinate is equal to the second right boundary value (x=Xmax2), and a line where the y-coordinate is equal to the second upper boundary value (y=Ymax2).

In an embodiment of the present disclosure, if the overlap direction DR is parallel to the x-axis, the processing device PR may remove the cropping target region CR from the second aerial image PH2-1 using either Equation 1 or Equation 2. If the overlap direction DR is parallel to the y-axis, the processing device PR may use either Equation 3 or Equation 4 to remove the cropping target region CR from the second aerial image PH2-1.

$$X min 2 = X min 1 + V min , X max 2 = X max 1 + V max \qquad [ Equation 1 ]$$

$$Y min 2 = Y min 1 , Y max 2 = Y max 1$$

$$X min 2 = X min 1 - V max , X max 1 = X max 1 - V min \qquad [ Equation 2 ]$$

$$Y min 2 = Y min 1 , Y max 1 = Y max 1$$

$$X min 2 = X min 1 , X max 2 = X max 1 \qquad [ Equation 3 ]$$

$$Y min 2 = Y min 1 + V min , Y max 2 = Y max 1 + V max$$

$$X min 2 = X min 1 , X max 2 = X max 1 \qquad [ Equation 4 ]$$

$$Y min 2 = Y min 1 - V min , Y max 2 = Y max 1 - V max$$

In each of the equations above, Xmin1 denotes the first left boundary value, Xmax1 denotes the first right boundary value, Ymin1 denotes the first lower boundary value, and Ymax1 denotes the first upper boundary value. Vmin and Vmax denote the minimum and maximum values, respectively, of the non-overlapping length DT. Xmin2, Xmax2, Ymin2, and Ymax2 represent the second left, right, bottom, and upper boundary values, respectively.

In the preprocessing step according to an embodiment of the present disclosure, if the overlap direction DR is opposite to the x-axis direction, the processing device PR may remove the cropping target region CR from the second aerial image PH2-1 using Equation 1.

In the preprocessing step, if the overlap direction DR is the same as the x-axis direction, the processing device PR may remove the cropping target region CR from the second aerial image PH2-1 using Equation 2. For example, as illustrated in FIGS. 13B and 13C, since the overlap direction DR is the same as the x-axis direction, the processing device PR may determine and remove the cropping target region CR using Equation 2.

In the preprocessing step, if the overlap direction DR is opposite to the y-axis direction, the processing device PR may remove the cropping target region CR from the second aerial image PH2-1 using Equation 3.

In the preprocessing step, if the overlap direction DR is the same as the y-axis direction, the processing device PR may remove the cropping target region CR from the second aerial image PH2-1 using Equation 4.

FIG. 13E illustrates the second aerial image PH2-2 after the cropping target region CR is removed from the second aerial image PH2-1 of FIG. 13D. Referring to FIG. 13E, the second aerial image used in the feature point matching step S12 may be the second aerial image PH2-2 from which the cropping target region CR has been removed.

In an embodiment of the present disclosure, the preprocessing step may be performed between the roof polygon generation step S11 and the feature point matching step S21. In an embodiment, the preprocessing step may be omitted.

In an embodiment of the present disclosure, at least one of the final texture generation step S40, the atlas generation step S50, the final spatial object generation step S60, the inpainting step S70, the super-resolution step S80, and the texture editing step may be omitted. Additionally, although FIG. 2 depicts that the inpainting step S70 and the super-resolution step S80 are performed sequentially, this is merely an example, and the order of the inpainting step S70, the super-resolution step S80, and the texture editing step is not limited thereto. That is, in other embodiments of the present disclosure, the order of the inpainting step S70, the super-resolution step S80, and the texture editing step may be freely modified.

Although certain embodiments have been described with reference to the accompanying drawings, those skilled in the art to which the present disclosure pertains will understand that various modifications and permutations can be made to the present disclosure without departing from the technical ideas and scope of the present disclosure as set forth in the appended claims. The embodiments disclosed herein are not intended to limit the technical ideas of the present disclosure, and all technical ideas within the scope of the appended claims and their equivalents should be interpreted as falling within the scope of the present disclosure.

What is claimed is:

1. A method for generating three-dimensional objects using aerial imagery, the method comprising:
an initial spatial object generation step in which an aerial image is an image of a building captured from the air using an imaging device, and a processing device generates an initial spatial object, which is a three-dimensional object corresponding to the building, based on a plurality of aerial images;
a mapping candidate selection step in which a building face is defined on a surface of the building, a building face normal vector perpendicular to the building face is defined, at least one of the plurality of aerial images includes an initial texture corresponding to the building face, each of the plurality of aerial images has a photographing direction vector defined from the imaging device toward the building face, and the processing device selects, as a mapping candidate aerial image, one of the plurality of aerial images that includes the initial texture and in which a dot product between the photographing direction vector and the building face normal vector is negative; and
an intermediate texture selection step in which the initial spatial object includes an object surface corresponding to the building face, and the processing device selects, as an intermediate texture, the initial texture having a largest area among a plurality of initial textures corresponding to a plurality of mapping candidate aerial images.

2. The method of claim 1, wherein a first aerial image and a second aerial image among the plurality of aerial images are aerial images capturing the building from different directions, and
wherein the initial spatial object generation step comprises:
a roof polygon generation step in which the processing device extracts a roof polygon corresponding to a roof of the building from the first aerial image;
a feature point matching step in which the processing device selects at least one first feature point having a predetermined characteristic from among a plurality of polygon pixels corresponding to the roof polygon in the first aerial image, and selects at least one second feature point corresponding to the first feature point from the second aerial image;
a spatial coordinate calculation step in which the processing device calculates feature point spatial coordinate information using a collinearity condition-based forward intersection method based on the first and second feature points, the feature point spatial coordinate information being one of a spatial coordinate of the first feature point and a spatial coordinate of the second feature point;
a building height calculation step in which the processing device calculates a height of the building using the feature point spatial coordinate information; and
a modeling step in which the processing device generates the initial spatial object based on the roof polygon and the height of the building.

3. The method of claim 2, wherein at least one of a first artificial intelligence model and a second artificial intelligence model is stored in the processing device, the first artificial intelligence model being configured to extract at least one first polygon as a vector image from the aerial image through polygon mapping, the second artificial intelligence model being configured to extract at least one second polygon as a raster image from the aerial image through object segmentation, a backbone of each of the first artificial intelligence model and the second artificial intelligence model being a neural network model, and
wherein, in the roof polygon generation step, the processing device extracts the roof polygon from the first aerial image using at least one of the first artificial intelligence model and the second artificial intelligence model.

4. The method of claim 3, wherein the second artificial intelligence model is configured to convert the second polygon into a vector image using a skeletonization algorithm and a loss function.

5. The method of claim 2, wherein in the feature point matching step, the processing device derives at least one of the first feature point and at least one of the second feature point using at least one of KAZE, ORB, and SIFT.

6. The method of claim 2, wherein in the feature point matching step, the processing device derives at least one of the second feature point using at least one of BFMatcher and FLANN.

7. The method of claim 2, wherein in the building height calculation step, the processing device further calculates the height of the building using a pre-stored digital elevation model (DEM).

8. The method of claim 2, wherein in the modeling step, the processing device performs tessellation on the roof polygon to divide the roof polygon into a plurality of triangles, and generates the initial spatial object based on the plurality of triangles and the height of the building.

9. The method of claim 8, wherein in the modeling step, the processing device performs the tessellation using a Sweeping Line Algorithm and an Ear Clipping Algorithm.

10. The method of claim 1, wherein in the mapping candidate selection step, the processing device selects the mapping candidate aerial image using a Backface Culling Algorithm.

11. The method of claim 1, further comprising a final texture generation step, wherein in the final texture generation step, the processing device generates a final texture by performing affine transformation and interpolation on the intermediate texture.

12. The method of claim 11, further comprising an atlas generation step,
wherein the building face is provided in plurality, and
wherein in the atlas generation step, the processing device iteratively performs the mapping candidate selection step, the intermediate texture selection step, and the final texture generation step for each of the plurality of building faces to generate a plurality of final textures, and generates an atlas using a Binary Space Partitioning Tree based on the plurality of final textures.

13. The method of claim 12, further comprising a final spatial object generation step,
wherein in the final spatial object generation step, the processing device generates a final spatial object by mapping the plurality of final textures to the initial spatial object based on the atlas.

14. The method of claim 13, further comprising an inpainting step, wherein in the inpainting step, the processing device performs inpainting on the final spatial object using a third artificial intelligence model.

15. The method of claim 13, further comprising a super-resolution step, wherein in the super-resolution step, the processing device enhances a resolution of the final spatial object using a super-resolution model, and
wherein a backbone of the super-resolution model is a neural network model, and the super-resolution model is trained with a plurality of images having different resolutions and changes resolutions of the plurality of images using an attention mechanism.

16. The method of claim 13, further comprising a texture editing step,
wherein in the texture editing step, one of the plurality of mapped final textures is a first final texture and another one of the plurality of mapped final textures is a second final texture, and the processing device edits the second final texture using at least a portion of a pre-stored predetermined texture or at least a portion of the first final texture.

17. The method of claim 2, wherein the initial spatial object generation step further comprises a preprocessing step,
wherein each of the plurality of aerial images includes a plurality of pixels arranged on a plane extending in an x-axis direction and a y-axis direction, and a position of each of the plurality of pixels is determined by x- and y-coordinates,
wherein the first aerial image includes a plurality of polygonal pixels corresponding to the roof polygon, the smallest value among the x-coordinates corresponding to the plurality of polygonal pixels is a first left boundary value and the largest value among the x-coordinates corresponding to the plurality of polygonal pixels is a first right boundary value, and the smallest value among the y-coordinates corresponding to the plurality of polygonal pixels is a first lower boundary value and the largest value among the y-coordinates corresponding to the plurality of polygonal pixels is a first upper boundary value,
wherein an area of the first aerial image overlapping with the second aerial image is an overlapping region, an area of the first aerial image not overlapping with the second aerial image is a non-overlapping region, an overlapping direction is a direction from the center of gravity of the non-overlapping region toward the center of gravity of the overlapping region, and a non-overlapping length is a length of the non-overlapping region measured in the overlapping direction,
wherein in the preprocessing step, when the overlapping direction is parallel to the x-axis direction, the processing device removes a cropping target region from the second aerial image using Equation 1 or Equation 2, and when the overlapping direction is parallel to the y-axis direction, the processing device removes the cropping target region from the second aerial image using Equation 3 or Equation 4, whereas the cropping target region is an outer region of the second aerial image that is bounded by a line with an x-coordinate equal to a second left boundary value, a line with a y-coordinate equal to a second lower boundary value, a line with an x-coordinate equal to a second right boundary value, and a line with a y-coordinate equal to a second upper boundary value,
$$X min 2 = X min 1 + V min , X max 2 = X max 1 + V max \qquad [ Equation 1 ]$$
$$Y min 2 = Y min 1 , Y max 2 = Y max 1$$
$$X min 2 = X min 1 - V max , X max 1 = X max 1 - V min \qquad [ Equation 2 ]$$
$$Y min 2 = Y min 1 , Y max 2 = Y max 1$$
$$X min 2 = X min 1 , X max 2 = X max 1 \qquad [ Equation 3 ]$$
$$Y min 2 = Y min 1 + V min , Y max 2 = Y max 1 + V max$$
$$X min 2 = X min 1 , X max 2 = X max 1 \qquad [ Equation 4 ]$$
$$Y min 2 = Y min 1 - V min , Y max 2 = Y max 1 - V max$$
wherein in each of Equations 1 to 4, Xmin2 is the second left boundary value, Ymin2 is the second lower boundary value, Xmax2 is the second right boundary value, Ymax2 is the second upper boundary value, Xmin1 is the first left boundary value, Xmax1 is the first right boundary value, Ymin1 is the first lower boundary value, Ymax1 is the first upper boundary value, Vmin is a minimum value of the non-overlapping length, and Vmax is a maximum value of the non-overlapping length, and
wherein in the feature point matching step, the second aerial image is the second aerial image with the cropping target region removed.

18. The method of claim 17, wherein in the preprocessing step, the processing device removes the cropping target region from the second aerial image using:
Equation 1 when the overlapping direction is opposite to the x-axis direction;
Equation 2 when the overlapping direction is the same as the x-axis direction;
Equation 3 when the overlapping direction is opposite to the y-axis direction; and
Equation 4 when the overlapping direction is the same as the y-axis direction.
